(19) United States
(12) Patent Application Publication
(10) Pub. No.: US 2024/0263000 A1
(43) Pub. Date: Aug. 8, 2024

(54) INJECTION MOLDING GRADE PVC TUBE AND METHOD FOR PRODUCING THE SAME

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHUN-LAI CHEN, TAIPEI (TW); WEN-YI WU, TAIPEI (TW)

(21) Appl. No.: 18/317,912

(22) Filed: May 15, 2023

(30) Foreign Application Priority Data
Feb. 3, 2023 (TW) 112103763

(51) Int. Cl. C08L 27/06

(52) U.S. Cl. CPC C08L 27/06; C08L 2205/03

(57) ABSTRACT

An injection molding grade PVC tube and a method for producing the same are provided. The injection molding grade PVC tube includes 100 parts by weight of a PVC resin, 2 to 8 parts by weight of a heat stabilizer, 1 to 20 parts by weight of a first additive, and 0.7 to 15 parts by weight of a second additive. The first additive includes a processing modifier and a heat resistance enhancer, and a weight ratio between the processing modifier and the heat resistance enhancer is within a range from 1:6.67 to 1:10. The PVC resin, the heat stabilizer, the first additive, and the second additive are powder-shaped. The injection molding grade PVC tube is formed by direct injection molding after hot melt extrusion of the PVC resin, the heat stabilizer, the first additive, and the second additive.

### CROSS-REFERENCE TO RELATED PATENT APPLICATION

This application claims the benefit of priority to Taiwan Patent Application No. 112103763, filed on Feb. 3, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a PVC tube and a method for producing the same, and more particularly to an injection molding grade PVC tube and a method for producing the same.

### BACKGROUND OF THE DISCLOSURE

A conventional injection molding grade tube that is mainly made of a PVC resin does not have a sufficient heat resistance, so as to not be applicable in a high temperature environment.

A conventional injection molding grade tube that is mainly made of a CPVC resin has a higher heat resistance. However, since an intermolecular force of the CPVC resin is strong and a chlorine content of the CPVC resin is high, such an injection molding grade tube has an excessive melt viscosity and a poor fluidity, cannot be easily processed, and can easily disintegrate. In addition, the conventional injection molding grade tube that is mainly made of the CPVC resin requires high processing torque, such that a conventional PVC molding apparatus cannot be used, thereby causing production difficulty.

### SUMMARY OF THE DISCLOSURE

In response to the above-referenced technical inadequacies, the present disclosure provides an injection molding grade PVC tube and a method for producing the same, so as to effectively improve poor heat resistance and processing difficulty of a conventional injection molding grade tube.

In order to solve the above-mentioned problems, one of the technical aspects adopted by the present disclosure is to provide an injection molding grade PVC tube. The injection molding grade PVC tube includes 100 parts by weight of a PVC resin, 2 to 8 parts by weight of a heat stabilizer, 1 to 20 parts by weight of a first additive, and 0.7 to 15 parts by weight of a second additive. A degree of polymerization of the PVC resin is within a range from 600 to 1000. The heat stabilizer is selected from the group consisting of an organotin, a calcium zinc stabilizer, a hydrotalcite stabilizer, and a rare earth stabilizer. The first additive includes a processing modifier and a heat resistance enhancer. The processing modifier is a vinyl chloride graft copolymer. The heat resistance enhancer is an α-methylstyrene acrylonitrile copolymer. A weight ratio between the processing modifier and the heat resistance enhancer is within a range from 1:6.67 to 1:10. The second additive at least includes a lubricant, an antioxidant, or a filler. The PVC resin, the heat stabilizer, the first additive, and the second additive are powder-shaped. The injection molding grade PVC tube is formed by direct injection molding after hot melt extrusion of the PVC resin, the heat stabilizer, the first additive, and the second additive.

In one of the possible or preferred embodiments, the vinyl chloride graft copolymer includes a vinyl chloride, a first grafted functional group, and a second grafted functional group, the first grafted functional group is ethylene and vinylidene chloride, and the second grafted functional group is vinyl acetate and vinyl tertiary carbonate.

In one of the possible or preferred embodiments, based on 100 wt % of the vinyl chloride graft copolymer, a content of the vinyl chloride is 65 wt % to 85 wt %, a content of the first grafted functional group is 10 wt % to 15 wt %, and a content of the second grafted functional group is 5 wt % to 15 wt %.

In one of the possible or preferred embodiments, a particle size of the first additive is within a range from 30 micrometers to 120 micrometers. In the first additive, a content of the processing modifier is 0.5 parts by weight to 5 parts by weight, and a content of the heat resistance enhancer is 0.5 parts by weight to 15 parts by weight.

In one of the possible or preferred embodiments, a particle size of the second additive is within a range from 0.1 micrometers to 100 micrometers. In the second additive, a content of the lubricant is 0.5 parts by weight to 3 parts by weight, a content of the antioxidant is 0.1 parts by weight to 2 parts by weight, and a content of the filler is 0.1 parts by weight to 3 parts by weight.

In one of the possible or preferred embodiments, the lubricant is selected from the group consisting of a polyethylene wax, an oxidized polyethylene wax, a fatty acid lubricant, a metal soap lubricant, and an organosilicon lubricant.

In one of the possible or preferred embodiments, the antioxidant is selected from the group consisting of a hindered phenolic antioxidant and a phosphite antioxidant.

In one of the possible or preferred embodiments, the injection molding grade PVC tube has a tensile strength within a range from 50.6 MPa to 51.4 MPa, an impact strength within a range from 30.4 J/m to 31.3 J/m, and a Vicat softening temperature within a range from 85.8° C. to 90.6° C.

In order to solve the above-mentioned problems, another one of the technical aspects adopted by the present disclosure is to provide a method for producing an injection molding grade PVC tube. The method includes a preparing step, a mixing step, and an injection molding step. The preparing step is implemented by preparing 100 parts by weight of a PVC resin, 2 to 8 parts by weight of a heat stabilizer, 1 to 20 parts by weight of a first additive, and 0.7 to 15 parts by weight of a second additive. A degree of polymerization of the PVC resin is within a range from 600 to 1000, and the heat stabilizer is selected from the group consisting of an organotin, a calcium zinc stabilizer, a hydrotalcite stabilizer, and a rare earth stabilizer. The first additive includes a processing modifier and a heat resistance enhancer, the processing modifier is a vinyl chloride graft copolymer, the heat resistance enhancer is an α-methylstyrene acrylonitrile copolymer, a weight ratio between the processing modifier and the heat resistance enhancer is within a range from 1:6.67 to 1:10, and the second additive at least includes a lubricant, an antioxidant, or a filler. The PVC resin, the heat stabilizer, the first additive, and the second additive are powder-shaped. The mixing step is implemented by mixing the PVC resin, the heat stabilizer, the first additive, and the second additive at a temperature within a range from 100° ° C. to 120° C., and reducing the temperature to between 35° C. and 50° C. for a continuous mixture, so as to form a mixed PVC resin material. The injection molding step is implemented by hot melting and injection molding the mixed PVC resin material via an injection molding machine at a temperature within a range from 170° C. to 200° ° C., so as to obtain form the injection molding grade PVC tube.

In one of the possible or preferred embodiments, the vinyl chloride graft copolymer includes a vinyl chloride, a first grafted functional group, and a second grafted functional group, the first grafted functional group is ethylene and vinylidene chloride, and the second grafted functional group is vinyl acetate and vinyl tertiary carbonate.

In one of the possible or preferred embodiments, based on 100 wt % of the vinyl chloride graft copolymer, a content of the vinyl chloride is 65 wt % to 85 wt %, a content of the first grafted functional group is 10 wt % to 15 wt %, and a content of the second grafted functional group is 5 wt % to 15 wt %.

In one of the possible or preferred embodiments, a particle size of the first additive is within a range from 30 micrometers to 120 micrometers. In the first additive, a content of the processing modifier is 0.5 parts by weight to 5 parts by weight, and a content of the heat resistance enhancer is 0.5 parts by weight to 15 parts by weight.

In one of the possible or preferred embodiments, a particle size of the second additive is within a range from 0.1 micrometers to 100 micrometers. In the second additive, a content of the lubricant is 0.5 parts by weight to 3 parts by weight, a content of the antioxidant is 0.1 parts by weight to 2 parts by weight, and a content of the filler is 0.1 parts by weight to 3 parts by weight. The lubricant is selected from the group consisting of a polyethylene wax, an oxidized polyethylene wax, a fatty acid lubricant, a metal soap lubricant, and an orgnaosilicon lubricant. The antioxidant is selected from the group consisting of a hindered phenolic antioxidant and a phosphite antioxidant.

In one of the possible or preferred embodiments, the injection molding grade PVC tube has a tensile strength within a range from 50.6 MPa to 51.4 MPa, an impact strength within a range from 30.4 J/m to 31.3 J/m, and a Vicat softening temperature within a range from 85.8° C. to 90.6° C.

Therefore, in the injection molding grade PVC tube and the method for producing the same provided by the present disclosure, by virtue of “the first additive including a processing modifier and a heat resistance enhancer, the processing modifier being a vinyl chloride graft copolymer, the heat resistance enhancer being an α-methylstyrene acrylonitrile copolymer, a weight ratio between the processing modifier and the heat resistance enhancer being within a range from 1:6.67 to 1:10, and the second additive at least including a lubricant, an antioxidant, or a filler” and “the PVC resin, the heat stabilizer, the first additive, and the second additive being powder-shaped,” the poor heat resistance and the processing difficulty of the conventional injection molding grade tube can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawing, in which:

FIG. 1 is a flowchart of a method for producing an injection molding grade PVC tube according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Injection Molding Grade PVC Tube]

An embodiment of the present disclosure provides an injection molding grade PVC tube. The injection molding grade PVC tube includes 100 parts by weight of a PVC resin, 2 to 8 parts by weight of a heat stabilizer, 1 to 20 parts by weight of a first additive, and 0.7 to 15 parts by weight of a second additive.

The PVC resin, the heat stabilizer, the first additive, and the second additive are powder-shaped, a particle size of the first additive is within a range from 30 micrometers to 120 micrometers, and a particle size of the second additive is within range from 0.1 micrometers to 100 micrometers. In other words, each component of the injection molding grade PVC tube are powder-shaped, and other PVC tubes that include components in other states (e.g., a liquid state) are not suitable to be compared to the injection molding grade PVC tube of the present embodiment.

The injection molding grade PVC tube is formed by direct injection molding after hot melt extrusion of the PVC resin, the heat stabilizer, the first additive, and the second additive. It should be noted that, a conventional PVC tube is usually produced through a sequence of extrusion, granulation, and injection molding. In contrast, the injection molding grade PVC tube of the present disclosure can be obtained without undergoing processes of extrusion and granulation, thereby achieving an effect of simplifying a production process.

A degree of polymerization of the PVC resin is within a range from 600 to 1000. It is worth mentioning that, if the degree of polymerization of the PVC resin is too high (e.g., greater than 1,000), a fluidity of the components of the injection molding grade PVC tube is poor after the components are mixed and hot melted, thereby causing processing difficulty.

A conventional injection molding grade tube that is mainly made of a CPVC resin has a higher heat resistance. However, since an intermolecular force of the CPVC resin is strong and a chlorine content of the CPVC resin is high, such an injection molding grade tube has an excessive melt viscosity and a poor fluidity, cannot be easily processed, and can easily disintegrate. In contrast, the injection molding grade PVC tube of the present embodiment can be limited to not include the CPVC resin, and the conventional injection molding grade tube mainly made of the CPVC resin is not suitable to be compared to the injection molding grade PVC tube of the present embodiment.

The heat stabilizer is selected from the group consisting of an organotin, a calcium zinc stabilizer, a hydrotalcite stabilizer, and a rare earth stabilizer. Preferably, the heat stabilizer is butyltin maleate.

The first additive includes a processing modifier and a heat resistance enhancer. The processing modifier is a vinyl chloride graft copolymer, and the heat resistance enhancer is an α-methylstyrene acrylonitrile copolymer. A weight ratio between the processing modifier and the heat resistance enhancer is within a range from 1:6.67 to 1:10, such that the injection molding grade PVC tube has a high heat resistance and can be easily processed. In other words, if the weight ratio between the processing modifier and the heat resistance enhancer is too high or too low, the injection molding grade PVC tube cannot have a desired heat resistance and a desired processability. In the present embodiment, a content of the processing modifier is 0.5 to 5 parts by weight, and a content of the heat resistance enhancer is 0.5 to 15 parts by weight.

Further, in the present embodiment, the vinyl chloride graft copolymer includes a vinyl chloride, a first grafted functional group, and a second grafted functional group, the first grafted functional group is ethylene and vinylidene chloride, and the second grafted functional group is vinyl acetate and vinyl tertiary carbonate.

More specifically, based on 100 wt % of the vinyl chloride graft copolymer, a content of the vinyl chloride is 65 wt % to 85 wt %, a content of the first grafted functional group is 10 wt % to 15 wt %, and a content of the second grafted functional group is 5 wt % to 15 wt %. In addition, in the present embodiment, a weight ratio between the ethylene and the vinylidene chloride in the first grafted functional group is 1:0.5 to 1:3, and a weight ratio between the vinyl acetate and the vinyl tertiary carbonate in the second grafted functional group is 1:0.2 to 1:4.

In the present embodiment, the vinyl chloride graft copolymer can be SRC sold by Zhong Plastic Union New Material Technology Hubei Co., Ltd., and the heat resistance enhancer can be Blendex 587S sold by Crompton, Hannanotech POLYB H810, or POLYMER NR-188, but the present disclosure is not limited thereto.

The second additive at least includes a lubricant, an antioxidant, or a filler. In the second additive of the present embodiment, a content of the lubricant is 0.5 parts by weight to 3 parts by weight, a content of the antioxidant is 0.1 parts by weight to 2 parts by weight, and a content of the filler is 0.1 parts by weight to 3 parts by weight.

Preferably, the lubricant is selected from the group consisting of a polyethylene wax, an oxidized polyethylene wax, a fatty acid lubricant, a metal soap slip, and a silicone lubricant, the antioxidant is selected from the group consisting of a hindered phenolic antioxidant and a phosphite antioxidant, and the filler is selected from the group consisting of heavy calcium carbonate, light calcium carbonate, nano calcium carbonate, a talcum powder, carbon black, and an organic pigment. In addition, a specific gravity of the filler is preferably less than 1.47, so as to meet relevant specifications and requirements.

In the present embodiment, the injection molding grade PVC tube has a tensile strength within a range from 50.6 MPa to 51.4 MPa, an impact strength within a range from 30.4 J/m to 31.3 J/m, and a Vicat softening temperature within a range from 85.8° C. to 90.6° C. The Vicat softening temperature refers to a temperature of a thermoplastic material when a sample is injected by a 1 square mm needle for 1 mm under a specific load and a specific constant heating condition. The Vicat softening temperature is one of several indicators for evaluating heat resistance of materials and physical and mechanical properties of reaction products under heating conditions.

### [Method for Producing Injection Molding Grade PVC Tube]

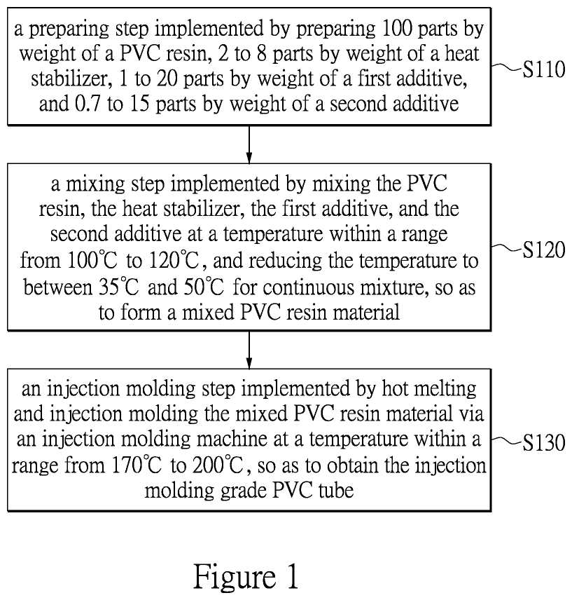

Referring to FIG. 1, the embodiment of the present disclosure further provides a method for producing an injection molding grade PVC tube. The above-mentioned injection molding grade PVC tube can be obtained by implementing the method, but the present disclosure is not limited thereto.

The method includes a preparing step S110, a mixing step S120, and an injection molding step S130.

The preparing step S110 is implemented by preparing 100 parts by weight of a PVC resin, 2 to 8 parts by weight of a heat stabilizer, 1 to 20 parts by weight of a first additive, and 0.7 to 15 parts by weight of a second additive. A degree of polymerization of the PVC resin is within a range from 600 to 1000, and the heat stabilizer is selected from the group consisting of an organotin, a calcium zinc stabilizer, a hydrotalcite stabilizer, and a rare earth stabilizer. The first additive includes a processing modifier and a heat resistance enhancer, the processing modifier is a vinyl chloride graft copolymer, the heat resistance enhancer is an α-methylstyrene acrylonitrile copolymer, a weight ratio between the processing modifier and the heat resistance enhancer is within a range from 1:6.67 to 1:10, and the second additive at least includes a lubricant, an antioxidant, or a filler. The PVC resin, the heat stabilizer, the first additive, and the second additive are powder-shaped, a particle size of the first additive is within a range from 30 micrometers to 120 micrometers, and a particle size of the second additive is within a range from 0.1 micrometers to 100 micrometers.

The mixing step S120 is implemented by mixing the PVC resin, the heat stabilizer, the first additive, and the second additive at a temperature within a range from 100° ° C. to 120° C., and reducing the temperature to between 35° C. and 50° C. for a continuous mixture, so as to form a mixed PVC resin material. Specifically, in the mixing step S120, the PVC resin, the heat stabilizer, the first additive, and the second additive are mixed under the temperature of from 100° ° C. to 120° ° C. for 600 seconds to 800 seconds, and then are discharged into a cold mix bucket with the temperature being reduced to between 35° C. and 50° C. The mixing process continues for 300 seconds to 500 seconds to form the mixed PVC resin material.

The injection molding step S130 is implemented by hot melting and injection molding the mixed PVC resin material via an injection molding machine at a temperature within a range from 170° C. to 200° C. and, so as to obtain the injection molding grade PVC tube. After the injection molding step S130, the method can further include other steps, such as a pressure holding step, a cooling and setting step, and a gate trimming step, but the present disclosure is not limited thereto.

Specifically, the vinyl chloride graft copolymer includes a vinyl chloride, a first grafted functional group, and a second grafted functional group, the first grafted functional group is ethylene and vinylidene chloride, and the second grafted functional group is vinyl acetate and vinyl tertiary carbonate. Based on 100 wt % of the vinyl chloride graft copolymer, a content of the vinyl chloride is 65 wt % to 85 wt %, a content of the first grafted functional group is 10 wt % to 15 wt %, and a content of the second grafted functional group is 5 wt % to 15 wt %.

A content of the processing modifier is 0.5 parts by weight to 5 parts by weight, and the heat resistance enhancer is 0.5 parts by weight to 15 parts by weight.

In the second additive, the lubricant is selected from the group consisting of a polyethylene wax, an oxidized polyethylene wax, a fatty acid lubricant, a metal soap slip, and a silicone lubricant, the antioxidant is selected from the group consisting of a hindered phenolic antioxidant and a phosphite antioxidant, and the filler is selected from the group consisting of heavy calcium carbonate, light calcium carbonate, nano calcium carbonate, a talcum powder, carbon black, and an organic pigment.

The injection molding grade PVC tube has a tensile strength within a range from 50.6 MPa to 51.4 MPa, an impact strength within a range from 30.4 J/m to 31.3 J/m, and a Vicat softening temperature within a range from 85.8° C. to 90.6° ° C.

### Experimental Results

For the injection molding grade PVC tube of each of Exemplary Examples 1 to 4 and Comparative Examples 1 to 2, components, a tensile strength, an impact strength, a Vicat softening temperature, a plasticizing time, and a plasticizing torque thereof are listed in Table 1 below, and relevant testing methods are described as follows.

A tensile strength test: tensile testing is performed on a plastic material according to the ASTM D638 standard, so as to obtain the tensile strength of the plastic material.

An impact strength test: notched Izod impact testing is performed according to the ASTM D256 standard, so as to generate characteristic values of impact strength and notch sensitivity at high strain rates in the form of thickness-dependent energy values. Such a test is usually performed at a normal climate (e.g., a temperature of 23° C. and a humidity of 50%) for testing the impact strength and the notched impact strength of the plastic.

A Vicat softening temperature (VST) test: a heat-resistance temperature is tested by a (HDT/VICAT) heat deflection tester, and the VST is determined according to GB/T 1633 (Plastics-Thermoplastic Materials-Determination of Vicat Softening Temperature (VST)), GB/T 8802 (Thermoplastics Pipes and Fitting-Determination of Vicat Softening Temperature), and the ASTM 1525 standard.

A plasticizing time and plasticizing torque test: a plasticizing rate is obtained by performing a rheological test using a torque rheometer (e.g., HAAKE PolyLab OS) at a specific temperature (from 170° C. to 200° C.) and a specific rotation speed (from 45 RPM to 60 RPM). A plasticizing time and a balancing torque of the formula under detection are taken as a basis for assessing productivity of the formula.

TABLE 1
[Components of Exemplary Examples and Comparative Examples
and Test Results of Their Physical and Chemical Properties]

| | | Exemplary | Exemplary | Exemplary | Exemplary |
|---|---|---|---|---|---|
| Item | | Example 1 | Example 2 | Example 3 | Example 4 |
| Parameter | content of PVC resin (part by weight) | 100 | 100 | 100 | 100 |
| of each | content of heat stabilizer (butyltin | 2 | 2.5 | 4 | 4 |
| component | maleate) (part by weight) | | | | |
| | content of ACR processing aid | | | | |
| | (Formosa Plastics P-201) | | | | |
| | (part by weight) | | | | |
| | content of processing modifier | 1.5 | 1.5 | 1.5 | 1.5 |
| | (vinyl chloride graft copolymer) | | | | |
| | (part by weight) | | | | |
| | content of heat resistance enhancer | | | 10 | 15 |
| | (α-methylstyrene acrylonitrile | | | | |
| | copolymer) (part by weight) | | | | |
| | content of toughener (MBS) | | 0.5 | | |
| | (part by weight) | | | | |
| | content of lubricant (oxidized | 0.5 | 0.5 | 0.5 | 0.5 |
| | polyethylene wax) (part by weight) | | | | |
| | content of antioxidant (I-1010) | 0.3 | 0.3 | 0.3 | 0.3 |
| | (part by weight) | | | | |
| | content of calcium carbonate | 1 | 1 | 1 | 1 |
| | (part by weight) | | | | |
| | content of carbon black (part by weight) | 0.0008 | 0.0008 | 0.0008 | 0.0008 |
| Test results | tensile strength (MPa) | 50.7 | 50.6 | 51.2 | 51.4 |
| | impact strength (J/m) | 30.4 | 30.6 | 30.8 | 31.3 |
| | Vicat softening temperature (° C.) | 77.0 | 77.1 | 85.8 | 90.6 |
| | plasticizing time (second) | 36 | 38 | 38 | 39 |
| | plasticizing torque (Nm) | 14.8 | 14.7 | 15.1 | 15.2 |

| | Comparative | Comparative |
|---|---|---|
| Item | Example 1 | Example 2 |

| | | | |
|---|---|---|---|
| Parameter | content of PVC resin (part by weight) | 100 | 100 |
| of each | content of heat stabilizer (butyltin | 5 | 5 |
| component | maleate) (part by weight) | | |
| | content of ACR processing aid | 1.5 | 1.5 |
| | (Formosa Plastics P-201) | | |
| | (part by weight) | | |
| | content of processing modifier | | |
| | (vinyl chloride graft copolymer) | | |
| | (part by weight) | | |
| | content of heat resistance enhancer | | |
| | (α-methylstyrene acrylonitrile | | |
| | copolymer) (part by weight) | | |
| | content of toughener (MBS) | | 0.5 |
| | (part by weight) | | |
| | content of lubricant (oxidized | 0.5 | 0.5 |
| | polyethylene wax) (part by weight) | | |
| | content of antioxidant (I-1010) | 0.3 | 0.3 |
| | (part by weight) | | |
| | content of calcium carbonate | 1 | 1 |
| | (part by weight) | | |
| | content of carbon black (part by weight) | 0.0008 | 0.0008 |
| Test results | tensile strength (MPa) | 49.1 | 49.6 |
| | impact strength (J/m) | 18.8 | 25.4 |
| | Vicat softening temperature (° C.) | 76.3 | 76.4 |
| | plasticizing time (second) | 38 | 37 |
| | plasticizing torque (Nm) | 15.8 | 15.9 |

### [Discussion of Test Results]

Compared with Comparative Example 1, the vinyl chloride graft copolymer in Exemplary Example 1 replaces an ACR processing aid having a gelation acceleration function. Not only can the plasticizing time be maintained, but a processing torque can also be reduced. Accordingly, a machine load is reduced, an injection molding processability is improved, and the Vicat softening temperature is increased.

Compared with Comparative Example 2, the vinyl chloride graft copolymer in Exemplary Examples 1 and 2 replaces the ACR processing aid and a toughener having the gelation acceleration function, and the impact strength is increased. This shows that the vinyl chloride graft copolymer added into the formula can have both gelation and toughening functions.

Compared with Comparative Examples 1 and 2, by adding both the vinyl chloride graft copolymer and the heat resistance enhancer in Exemplary Examples 3 and 4, not only can the same plasticizing function be maintained, but the impact strength can also be improved. In addition, the Vicat softening temperature of a tube can be significantly increased.

Specifically, the injection molding grade PVC tubes of Exemplary Examples 1 to 4 can have the tensile strength within a range from 50.6 MPa to 51.4 MPa, the impact strength within a range from 30.4 J/m to 31.3 J/m, the Vicat softening temperature within a range from 77.0° C. to 90.6° C., the plasticizing time within a range from 36 seconds to 39 seconds, and the plasticizing torque within a range from 14.7 Nm to 15.2 Nm.

In contrast, the injection molding grade PVC tubes of Comparative Examples 1 to 2 have the tensile strength within a range from 49.1 MPa to 49.6 MPa, the impact strength within a range from 18.8 J/m to 25.4 J/m, the Vicat softening temperature within a range from 76.3° C. to 76.4° ° C., the plasticizing time within a range from 37 seconds to 38 seconds, and the plasticizing torque within a range from 15.8 Nm to 15.9 Nm.

### Beneficial Effects of the Embodiment

In conclusion, in the injection molding grade PVC tube and the method for producing the same provided by the present disclosure, by virtue of “the first additive including a processing modifier and a heat resistance enhancer, the processing modifier being a vinyl chloride graft copolymer, the heat resistance enhancer being an α-methylstyrene acrylonitrile copolymer, a weight ratio between the processing modifier and the heat resistance enhancer being within a range from 1:6.67 to 1:10, and the second additive at least including a lubricant, an antioxidant, or a filler” and “the PVC resin, the heat stabilizer, the first additive, and the second additive being powder-shaped,” the poor heat resistance and the processing difficulty of the conventional injection molding grade tube can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An injection molding grade PVC tube, comprising:
100 parts by weight of a PVC resin, wherein a degree of polymerization of the PVC resin is within a range from 600 to 1,000;
2 to 8 parts by weight of a heat stabilizer, wherein the heat stabilizer is selected from the group consisting of an organotin, a calcium zinc stabilizer, a hydrotalcite stabilizer, and a rare earth stabilizer;
1 to 20 parts by weight of a first additive, wherein the first additive includes:
a processing modifier, wherein the processing modifier is a vinyl chloride graft copolymer; and
a heat resistance enhancer, wherein the heat resistance enhancer is an α-methylstyrene acrylonitrile copolymer, and a weight ratio between the processing modifier and the heat resistance enhancer is within a range from 1:6.67 to 1:10; and
0.7 to 15 parts by weight of a second additive, wherein the second additive at least includes a lubricant, an antioxidant, or a filler;
wherein the PVC resin, the heat stabilizer, the first additive, and the second additive are powder-shaped;
wherein the injection molding grade PVC tube is formed by direct injection molding after hot melt extrusion of the PVC resin, the heat stabilizer, the first additive, and the second additive.

2. The injection molding grade PVC tube according to claim 1, wherein the vinyl chloride graft copolymer includes a vinyl chloride, a first grafted functional group, and a second grafted functional group, the first grafted functional group is ethylene and vinylidene chloride, and the second grafted functional group is vinyl acetate and vinyl tertiary carbonate.

3. The injection molding grade PVC tube according to claim 2, wherein, based on 100 wt % of the vinyl chloride graft copolymer, a content of the vinyl chloride is 65 wt % to 85 wt %, a content of the first grafted functional group is 10 wt % to 15 wt %, and a content of the second grafted functional group is 5 wt % to 15 wt %.

4. The injection molding grade PVC tube according to claim 1, wherein a particle size of the first additive is within a range from 30 micrometers to 120 micrometers; wherein, in the first additive, a content of the processing modifier is 0.5 parts by weight to 5 parts by weight, and a content of the heat resistance enhancer is 0.5 parts by weight to 15 parts by weight.

5. The injection molding grade PVC tube according to claim 1, wherein a particle size of the second additive is within a range from 0.1 micrometers to 100 micrometers; wherein, in the second additive, a content of the lubricant is 0.5 parts by weight to 3 parts by weight, a content of the antioxidant is 0.1 parts by weight to 2 parts by weight, and a content of the filler is 0.1 parts by weight to 3 parts by weight.

6. The injection molding grade PVC tube according to claim 1, wherein the lubricant is selected from the group consisting of a polyethylene wax, an oxidized polyethylene wax, a fatty acid lubricant, a metal soap lubricant, and an organosilicon lubricant.

7. The injection molding grade PVC tube according to claim 1, wherein the antioxidant is selected from the group consisting of a hindered phenolic antioxidant and a phosphite antioxidant.

8. The injection molding grade PVC tube according to claim 1, wherein the injection molding grade PVC tube has a tensile strength within a range from 50.6 MPa to 51.4 MPa, an impact strength within a range from 30.4 J/m to 31.3 J/m, and a Vicat softening temperature within a range from 85.8° ° C. to 90.6° C.

9. A method for producing an injection molding grade PVC tube, comprising:
a preparing step implemented by preparing 100 parts by weight of a PVC resin, 2 to 8 parts by weight of a heat stabilizer, 1 to 20 parts by weight of a first additive, and 0.7 to 15 parts by weight of a second additive, wherein a degree of polymerization of the PVC resin is within a range from 600 to 1,000, and the heat stabilizer is selected from the group consisting of an organotin, a calcium zinc stabilizer, a hydrotalcite stabilizer, and a rare earth stabilizer; wherein the first additive includes a processing modifier and a heat resistance enhancer, the processing modifier is a vinyl chloride graft copolymer, the heat resistance enhancer is an α-methylstyrene acrylonitrile copolymer, a weight ratio between the processing modifier and the heat resistance enhancer is within a range from 1:6.67 to 1:10, and the second additive at least includes a lubricant, an antioxidant, or a filler; wherein the PVC resin, the heat stabilizer, the first additive, and the second additive are powder-shaped;
a mixing step implemented by mixing the PVC resin, the heat stabilizer, the first additive, and the second additive at a temperature within a range from 100° C. to 120° C., and reducing the temperature to between 35° C. and 50° C. for a continuous mixture, so as to form a mixed PVC resin material; and
an injection molding step implemented by hot melting and injection molding the mixed PVC resin material via an injection molding machine at a temperature within a range from 170° C. to 200° C., so as to obtain the injection molding grade PVC tube.

10. The method according to claim 9, wherein the vinyl chloride graft copolymer includes a vinyl chloride, a first grafted functional group, and a second grafted functional group, the first grafted functional group is ethylene and vinylidene chloride, and the second grafted functional group is vinyl acetate and vinyl tertiary carbonate.

11. The method according to claim 10, wherein, based on 100 wt % of the vinyl chloride graft copolymer, a content of the vinyl chloride is 65 wt % to 85 wt %, a content of the first grafted functional group is 10 wt % to 15 wt %, and a content of the second grafted functional group is 5 wt % to 15 wt %.

12. The method according to claim 9, wherein a particle size of the first additive is within a range from 30 micrometers to 120 micrometers; wherein, in the first additive, a content of the processing modifier is 0.5 parts by weight to 5 parts by weight, and a content of the heat resistance enhancer is 0.5 parts by weight to 15 parts by weight.

13. The method according to claim 9, wherein a particle size of the second additive is within range from 0.1 micrometers to 100 micrometers, and in the second additive, a content of the lubricant is 0.5 parts by weight to 3 parts by weight, a content of the antioxidant is 0.1 parts by weight to 2 parts by weight, and a content of the filler is 0.1 parts by weight to 3 parts by weight; wherein the lubricant is selected from the group consisting of a polyethylene wax, an oxidized polyethylene wax, a fatty acid lubricant, a metal soap lubricant, and an organosilicon lubricant; wherein the antioxidant is selected from the group consisting of a hindered phenolic antioxidant and a phosphite antioxidant.

14. The method according to claim 9, wherein the injection molding grade PVC tube has a tensile strength within a range from 50.6 MPa to 51.4 MPa, an impact strength within a range from 30.4 J/m to 31.3 J/m, and a Vicat softening temperature within a range from 85.8° C. to 90.6° ° C.
